(19) United States
(12) Patent Application Publication
(10) Pub. No.: US 2026/0313725 A1
(43) Pub. Date: Oct. 8, 2026

(54) METHODS AND APPARATUSES FOR SIDELINK RELAY

(71) Applicant: LENOVO (BEIJING) LIMITED, Beijing (CN)

(72) Inventors: Lianhai Wu, Beijing (CN); Jing Han, Beijing (CN); Ran Yue, Beijing (CN); Jie Hu, Beijing (CN)

(21) Appl. No.: 19/483,393

(22) PCT Filed: May 11, 2023
(86) PCT No.: PCT/CN2023/093631

§ 371 Date: Nov. 11, 2025

(51) Int. Cl. H04W 76/14; H04W 76/30; H04W 88/04

(52) U.S. Cl. CPC H04W 76/14; H04W 76/30; H04W 88/04

(57) ABSTRACT

The present application relates to methods and apparatuses for sidelink relay. An embodiment of the present disclosure provides a user equipment (UE) comprising: a transceiver and a processor coupled to the transceiver. The processor is configured to:establish a first PC5 radio resource control (RRC) connection of a first hop between the first UE and a relay UE, wherein a second PC5 RRC connection of a second hop between the relay UE and a second UE is established; and establish a third PC5 RRC connection of an end-to-end PC5 link between the first UE and the second UE via the relay UE.

### TECHNICAL FIELD

The present disclosure relates to wireless communications, and particularly relates to methods and apparatuses for sidelink (SL) relay.

### BACKGROUND OF THE INVENTION

SL communication includes, for example, new radio (NR) SL communication and vehicle-to-everything (V2X) SL communication, and supports user equipment (UE) to UE direct communication. SL communication between two UEs may be performed via a PC5 interface. SL transmission and reception over the PC5 interface are supported when a UE is inside or outside a network coverage, e.g., a new generation (NG) radio access network (RAN) coverage.

To further explore the coverage extension for SL based communication, UE-to-UE (U2U) relay (also referred to as SL relay herein) may be applied. The U2U relay scenarios may involve new issues to be resolved.

### SUMMARY

According to an embodiment of the present disclosure, a first UE may include: a transceiver and a processor coupled to the transceiver, wherein the processor is configured to: establish a first PC5 radio resource control (RRC) connection of a first hop between the first UE and a relay UE, wherein a second PC5 RRC connection of a second hop between the relay UE and a second UE is established; and establish a third PC5 RRC connection of an end-to-end PC5 link between the first UE and the second UE via the relay UE.

In some embodiments, the first UE is configured with a first value for a timer for reconfiguration of the first PC5 RRC connection, and a second value for a timer for reconfiguration of the third PC5 RRC connection.

In some embodiments, the processor is further configured to declare a failure for the third PC5 RRC connection when at least one of the following situations occurs: the timer for reconfiguration of the third PC5 RRC connection expires, wherein the timer for reconfiguration of the third PC5 RRC connection is started when the first UE transmits an RRC reconfiguration message including end-to-end PC5 configuration information to the second UE; an RRC reconfiguration failure message is received from the second UE; an SL radio link failure (RLF) on the first hop is detected; a signal strength on the first hop is lower than a first threshold; or a notification message or a release message is received from the relay UE which indicates that an SL RLF on the second hop is detected or a signal strength on the second hop is lower than a second threshold.

In some embodiments, the processor is further configured to release the third PC5 RRC connection upon declaring the failure for the third PC5 RRC connection.

In some embodiments, the processor is further configured to transmit, via the transceiver, information indicating the failure for the third PC5 RRC connection to a base station (BS).

In some embodiments, the information indicating the failure for the third PC5 RRC connection comprises a cause for the failure.

In some embodiments, a value of the cause for the failure comprises: an end-to-end RLF, an end-to-end configuration failure, an SL RLF on the first hop, a low signal strength on the first hop, an SL RLF on the second hop, or a low signal strength on the second hop.

In some embodiments, the processor is further configured to keep a configuration for the third PC5 RRC connection and initiate recovery of the third PC5 RRC connection when the failure for the third PC5 RRC connection is declared.

In some embodiments, the processor is further configured to release the third PC5 RRC connection when a recovery timer expires, wherein the recovery timer is started upon initiating the recovery of the third PC5 RRC connection or declaring the failure for the third PC5 RRC connection.

In some embodiments, to keep the configuration for the third PC5 RRC connection, the processor is configured to indicate to an upper layer to maintain a keep-alive procedure for the end-to-end PC5 link.

In some embodiments, the processor is further configured to determine whether layer-2 identifiers (IDs) or local IDs are used in sidelink relay adaption protocol (SRAP) headers for the first hop and the second hop after the third PC5 RRC connection is established.

In some embodiments, in the case that the processor determines to use the local IDs in the SRAP headers for the first hop and the second hop, the processor is configured to: assign the local IDs for the first UE and the second UE respectively, or inform the relay UE to assign the local IDs for the first UE and the second UE respectively.

In some embodiments, the processor is further configured to receive, via the transceiver and from the relay UE, an indication indicating that layer-2 IDs are used in SRAP headers for the first hop and the second hop, or local IDs for the first UE and the second UE respectively.

In some embodiments, the processor is configured to receive, via the transceiver and from a BS, local IDs for the first UE and the second UE respectively.

Another embodiment of the present disclosure provides a BS. The BS may include a transceiver and a processor coupled to the transceiver, wherein the processor is configured to transmit, via the transceiver, end-to-end PC5 configuration information for a PC5 RRC connection of an end-to-end PC5 link between a first UE and a second UE.

In some embodiments, the processor is configured to receive, via the transceiver, information indicating a failure for the PC5 RRC connection from the first UE, and wherein the information indicates at least one of the following situations: a timer for reconfiguration of the PC5 RRC connection expires; the first UE receives an RRC reconfiguration failure message from the second UE; an SL RLF on a first hop between the first UE and a relay UE is detected; a signal strength on the first hop is lower than a first threshold; an SL RLF on a second hop between the relay UE and the second UE is detected; or a signal strength on the second hop is lower than a second threshold.

In some embodiments, in the case that the PC5 RRC connection is established, the processor is further configured to determine whether layer-2 IDs or local IDs are used in SRAP headers for a first hop between the first UE and a relay UE and a second hop between the relay UE and the second UE.

In some embodiments, in the case that the processor determines to use the local IDs in the SRAP headers for the first hop and the second hop, the processor is configured to assign the local IDs for the first UE and the second UE respectively, and transmit, via the transceiver, the local IDs to the first UE and/or the second UE.

Yet another embodiment of the present disclosure provides a relay UE. The relay UE may include a transceiver and a processor coupled to the transceiver, wherein the processor is configured to: establish a first PC5 RRC connection of a first hop between a first UE and the relay UE; establish a second PC5 RRC connection of a second hop between a second UE and the relay UE; and transfer a data unit received from the first UE to the second UE.

In some embodiments, the processor is further configured to assign local IDs to be used in SRAP headers for the first hop and the second hop in response to receiving an indication from the first UE indicating to assign the local IDs.

In some embodiments, the processor is further configured to determine whether layer-2 IDs or local IDs are used in SRAP headers for the first hop and the second hop.

In some embodiments, in the case that the processor determines to use the layer-2 IDs in the SRAP headers for the first hop and the second hop, the processor is configured to transmit, via the transceiver, an indication of the determination to the first UE and the second UE.

In some embodiments, in the case that the processor determines to use the local IDs in the SARP headers for the first hop and the second hop, the processor is configured to assign the local IDs for the first UE and the second UE respectively.

A further embodiment of the present disclosure provides a method performed by a first UE. The method may include: establishing a first PC5 RRC connection of a first hop between the first UE and a relay UE, wherein a second PC5 RRC connection of a second hop between the relay UE and a second UE is established; and establishing a third PC5 RRC connection of an end-to-end PC5 link between the first UE and the second UE via the relay UE.

Another further embodiment of the present disclosure provides a method performed by a BS. The method may include transmitting end-to-end PC5 configuration information for a PC5 RRC connection of an end-to-end PC5 link between a first UE and a second UE.

Still another embodiment of the present disclosure provides a method performed by a relay UE. The method may include: establishing a first PC5 RRC connection of a first hop between a first UE and the relay UE; establishing a second PC5 RRC connection of a second hop between a second UE and the relay UE; and transferring a data unit received from the first UE to the second UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIG. 2 illustrates a flowchart of an exemplary method for SL relay according to some embodiments of the present disclosure.

FIG. 3 illustrates a flowchart of an exemplary method for SL relay according to some other embodiments of the present disclosure.

FIG. 4 illustrates a flowchart of an exemplary method for SL relay according to some other embodiments of the present disclosure.

FIG. 5 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3^{rd} generation partnership project (3GPP) long term evolution (LTE), LTE-Advanced (LTE-A), 3GPP 4G, 3GPP 5G NR, 3GPP Release 16 and onwards, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 is a schematic diagram illustrating an exemplary wireless communication system 100 according to some embodiments of the present application.

Referring to FIG. 1, the wireless communication system 100 may include a BS 101 and a number of UEs (e.g., UE 102a, UE 102b, and UE 102c). Although only one BS 101 and three UEs are shown for simplicity, it should be contemplated that the wireless communication system 100 may include any number of BSs or UEs in accordance with some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a next generation node B (gNB), a home node-B, a relay node, or a device, or described using other terminology used in the art. The BS 101 is generally part of a radio access network that may include a controller communicably coupled to the BS 101.

The UEs (e.g., UE 102a, UE 102b, and UE 102c) within the wireless communication system 100 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UEs may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UEs within the wireless communication system 100 may include wearable devices, such as smart watches, fitness bands, optical head-mounted displays, or the like. Moreover, each of the UEs within the wireless communication system 100 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 101 may be distributed over a geographic region. In the case that a UE (e.g., UE 102a, UE 102b, or UE 102c) is inside the coverage of the BS 101, the UE may transmit information or data to the BS 101 and receive control information or data from the BS 101, for example, via LTE or NR Uu interface. In some cases, a UE outside the coverage of the BS 101 may communicate with the BS 101 via one or more relay UEs.

Two UEs may perform SL communications with each other via a PC5 interface. In some cases, a UE may communicate with another UE via a direct link between them. In some other cases, a UE may communicate with another UE via one or more relay UEs. That is, the UE may establish a PC5 RRC connection of an end-to-end (e2e) PC5 link with another UE via at least one relay UE. For example, as shown in FIG. 1, the UE 102a may establish a PC5 RRC connection of an end-to-end PC5 link with the UE 102b via the UE 102c. To achieve this, a first PC5 RRC connection of a direct link between the UE 102a and the UE 102c may be established and a second PC5 RRC connection of a direct link between the UE 102c and the UE 102b may be established. Then, the PC5 RRC connection of the end-to-end PC5 link between the UE 102a and the UE 102b may be established, and the UE102c may act as a relay UE and transfer data unit(s) received from one of the UE 102a and the UE 102b to the other. Each of the UE 102a and the UE 102b may be referred to as a remote UE, which means that it communicates with another UE via a relay UE. In the case of a communication direction from the UE 102a to the UE 102b, the direct link between the UE 102a and the UE 102c may be referred to as a first hop, and the direct link between the UE 102c and the UE 102b may be referred to as a second hop, as shown in FIG. 1.

The example shown in FIG. 1 illustrates a single UE-to-UE relay case for simplicity, i.e., only one relay UE (e.g., UE 102c) is used for the PC5 RRC connection of the end-to-end PC5 link between two UEs (e.g., the UE 102a and the UE 102b). It is contemplated that a multi-hop (more than one hop) UE-to-UE relay case in which more relay UEs are used for a PC5 RRC connection of an end-to-end PC5 link between two UEs is also supported.

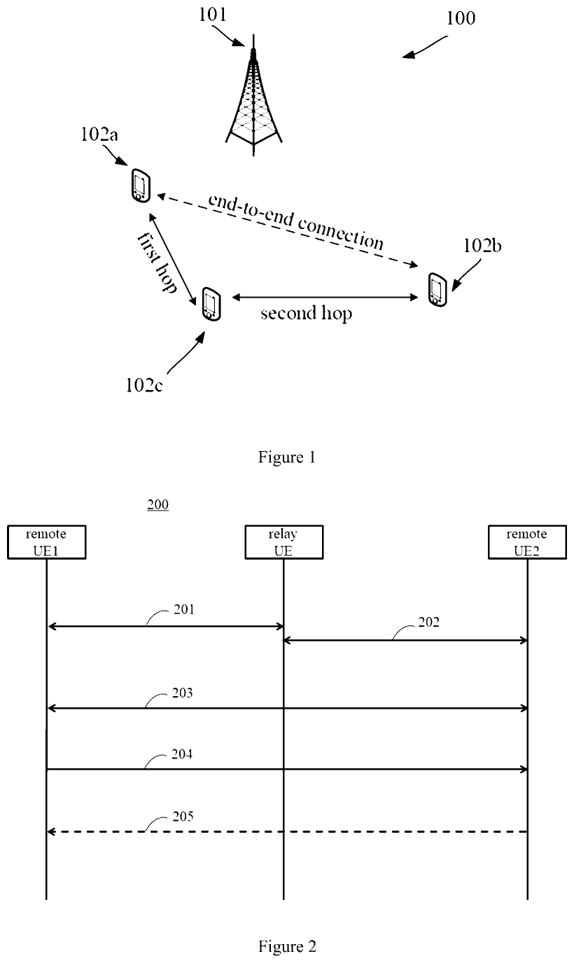

FIG. 2 illustrates a flowchart of an exemplary method 200 for SL relay according to some embodiments of the present disclosure. The method 200 illustrated in FIG. 2 may be performed by at least three entities, e.g., a remote UE1 (e.g., UE 102a or UE 102b), a remote UE2 (e.g., UE 102b or UE 102a) and a relay UE (e.g., UE102c). Although the method 200 is illustrated in a system level, persons skilled in the art can understand that the method implemented in the three entities can be separately implemented and incorporated in other apparatus with the like functions. It is also contemplated that the method 200 may include additional steps not shown. It is also contemplated that the method 200 may be extended to the multi-hop UE-to-UE relay case.

In step 201, the remote UE1 and the relay UE may establish a first PC5 RRC connection of a first hop between them.

In step 202, the relay UE and the remote UE2 may establish a second PC5 RRC connection of a second hop between them. Step 202 may occur after, before, or simultaneously with step 201.

In step 203, after the first PC5 RRC connection and the second PC5 RRC connection are established, the remote UE1 and the remote UE2 may establish a third PC5 RRC connection of an end-to-end PC5 link between them via the relay UE.

In step 204, after the third PC5 RRC connection between the remote UE1 and the remote UE2 is established, some configurations may be exchanged between the remote UE1 and the remote UE2. For example, the remote UE1 may transmit an RRC reconfiguration message via the relay UE to the remote UE2, which is transparent to the relay UE. In some embodiments, the RRC reconfiguration message may carry end-to-end PC5 configuration information (or parameters). In some embodiments, the end-to-end PC5 configuration information may include end-to-end service data adaptation protocol (SDAP) and packet data convergence protocol (PDCP) configuration parameters associated with a quality of service (QoS) profile.

In some embodiments, the end-to-end PC5 configuration information may be preconfigured to the remote UE1, which may refer to that: the end-to-end PC5 configuration information may be hard-wired into the remote UE1 or stored on a subscriber identity module (SIM) or universal subscriber identity module (USIM) card for the remote UE1, such that the remote UE1 may obtain the end-to-end PC5 configuration information within the remote UE1. In some embodiments, the remote UE1 may receive the end-to-end PC5 configuration information from a BS (e.g., BS 101), e.g., when the remote UE1 is in the coverage of the BS.

In some embodiments, the remote UE1 is configured with a first value for a first timer for reconfiguration of the first PC5 RRC connection, and is configured with a second value for a second timer for reconfiguration of the third PC5 RRC connection. In some embodiments, the first value may be different from the second value. For example, considering that the third PC5 RRC connection involves more hops than the first PC5 RRC connection, the second value may be larger than the first value. In some embodiments, both the first timer and the second timer may be T400 as defined in 3GPP standard documents. In some other embodiments, the first timer may be T400 while the second timer may be a different timer.

In some embodiments, the second value is associated with the number of relay UEs involved in the third PC5 RRC connection of the end-to-end PC5 link between the remote UE1 and the remote UE2. For example, the remote UE1 may be configured with a timer value #1 for reconfiguration of a PC5 RRC connection involving only one relay UE, a timer value #2 for reconfiguration of a PC5 RRC connection involving two relay UEs, and a timer value #3 for reconfiguration of a PC5 RRC connection involving three relay UEs; these values may be different from each other.

When the remote UE1 transmits the RRC reconfiguration message for the third PC5 RRC connection, it may start the second timer.

In step 205, the remote UE1 may receive a response from the remote UE2 via the relay UE.

In the case that the response is an RRC reconfiguration complete message, configuration between the remote UE1 and the remote UE2 is successful. Upon receiving the RRC reconfiguration complete message, the remote UE1 may stop the second timer. Then, data may be transmitted from the remote UE1 to the remote UE2.

In the case that the response is an RRC reconfiguration failure message, the configuration between the remote UE1 and the remote UE2 fails. Upon receiving the RRC reconfiguration failure message, the remote UE1 may stop the second timer and declare a failure for the third PC5 RRC connection. In such case, the failure may be due to an end-to-end configuration failure.

In some embodiments, the remote UE1 may not receive any response from the remote UE2 before the second timer expires. Then, the remote UE1 may declare a failure for the third PC5 RRC connection upon expiry of the second timer. In such case, the failure may be due to an end-to-end RLF.

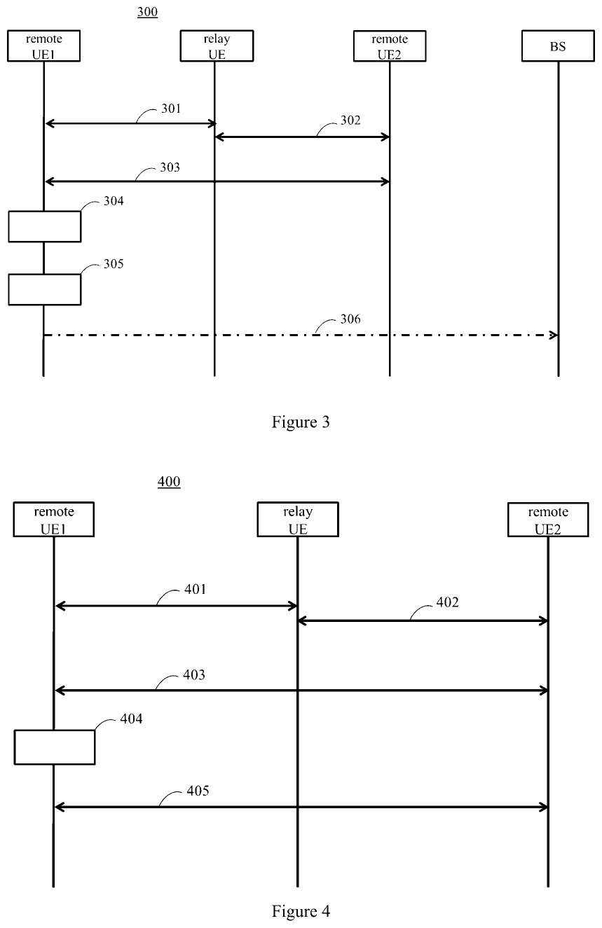

FIG. 3 illustrates a flowchart of an exemplary method 300 for SL relay according to some embodiments of the present disclosure.

The method 300 illustrated in FIG. 3 may be performed by at least four entities, e.g., a remote UE1 (e.g., UE 102a or UE 102b), a remote UE2 (e.g., UE 102b or UE 102a), a relay UE (e.g., UE 102c) and a BS (e.g., BS 101). Although the method 300 is illustrated in a system level, persons skilled in the art can understand that the method implemented in the four entities can be separately implemented and incorporated in other apparatus with the like functions. It is also contemplated that the method 300 may include additional steps not shown. It is also contemplated that the method 300 may be extended to the multi-hop UE-to-UE relay case.

Steps 301, 302, and 303 may be the same as steps 201, 202, and 203, respectively. That is, in step 301, a first PC5 RRC connection of a first hop between the remote UE1 and the relay UE may be established; in step 302, a second PC5 RRC connection of a second hop between the relay UE and the remote UE2 may be established; and in step 303, after the first PC5 RRC connection and the second PC5 RRC connection are established, a third PC5 RRC connection of an end-to-end PC5 link between the remote UE1 and the remote UE2 may be established. After the third PC5 RRC connection between the remote UE1 and the remote UE2 is established, some configurations may be exchanged between the remote UE1 and the remote UE2. For example, the remote UE1 may transmit an RRC reconfiguration message as described above.

In step 304, the remote UE1 may declare a failure for the third PC5 RRC connection when at least one of the following situations occurs:
a timer (e.g., the second timer as described above) for reconfiguration of the third PC5 RRC connection expires;
an RRC reconfiguration failure message is received from the remote UE2;
an SL RLF on the first hop is detected;
a signal strength on the first hop is lower than a first threshold; or
a notification message or a release message is received from the relay UE which indicates that an SL RLF on the second hop is detected or a signal strength on the second hop is lower than a second threshold.

It is contemplated that in the case that more relay UEs are involved in the third PC5 RRC connection, there will be more situations that render the remote UE1 to declare a failure for the third PC5 RRC connection.

An SL RLF on a hop (e.g., the first hop, the second hop, etc.) is detected if at least one of the following situations occurs:
an indication is received from an SL radio link control (RLC) entity indicating that a maximum number of retransmissions for a specific destination has been reached;
a timer for PC5 RRC reconfiguration expires for a specific destination;
an indication is received from a medium access control (MAC) entity indicating that a maximum number of consecutive hybrid automatic repeat request (HARQ) discontinuous transmission (DTX) for a specific destination has been reached; or
an integrity check failure indication is received from an SL PDCP entity concerning sidelink signaling radio bear (SL-SRB) 2 or SL-SRB3 for a specific destination.

In step 305, after declaring a failure for the third PC5 RRC connection, the remote UE1 may release the third PC5 RRC connection. In some embodiments, the remote UE1 may further release a configuration for the third PC5 RRC connection upon declaring the failure for the third PC5 RRC connection. For example, the remote UE1 may perform at least one of the following operations:
releasing end-to-end data radio bearers (DRBs) associated with the remote UE2;
releasing end-to-end signaling radio bears (SRBs) associated with the remote UE2;
releasing PC5 relay RLC channels of the first hop if configured;
discarding an NR sidelink communication related configuration of the first hop;
resetting a sidelink specific MAC of the first hop;
considering that the end-to-end PC5 RRC connection is released for the remote UE2;
indicating the release of the end-to-end PC5 RRC connection to upper layers for the remote UE2 (i.e. the end-to-end PC5 RRC connection is unavailable).

Although not shown, the remote UE2 may also release the third PC5 RRC connection and the configuration for the third PC5 RRC connection in a similar manner.

After releasing the third PC5 RRC connection, the remote UE2 may perform a relay reselection procedure to establish a new end-to-end PC5 RRC connection with the remote UE2.

In some embodiments, in the case that the remote UE1 is in a coverage of the BS, in step 306, it may transmit information indicating the failure for the third PC5 RRC connection to the BS after declaring the failure for the third PC5 RRC connection. For example, the remote UE1 may transmit SL UE information including the information indicating the failure. The information may include a cause for the failure. The failure information could be one of e2e RLF, e2e configuration failure, RLF on the first hop, low signal strength on the first hop, sidelink RLF on the second hop, or low signal strength on the second hop. For example, the information may be a parameter sl-Failure defined as:

sl-Failure ENUMERATED {
e2e RLF, e2e configuration failure, RLF on the first hop,
low signal strength on the first hop,
sidelink RLF on the second hop,
low signal strength on the second hop
}

Each value may represent a cause for the failure as follows:
e2e RLF: a timer (e.g., the second timer as described above) for reconfiguration of the third PC5 RRC connection expires;
e2e configuration failure: an RRC reconfiguration failure message is received from the remote UE2;
RLF on the first hop: an SL RLF on the first hop is detected;
low signal strength on the first hop: a signal strength on the first hop is lower than a first threshold;
sidelink RLF on the second hop: an SL RLF on the second hop is detected; and
low signal strength on the second hop: a signal strength on the second hop is lower than a second threshold.

It is contemplated that in the case that more relay UEs are involved in the third PC5 RRC connection, sl-Failure may have more possible values.

FIG. 4 illustrates a flowchart of an exemplary method 400 for SL relay according to some embodiments of the present disclosure.

The method 400 illustrated in FIG. 4 may be performed by at least three entities, e.g., a remote UE1 (e.g., UE 102a or UE 102b), a remote UE2 (e.g., UE 102b or UE 102a) and a relay UE (e.g., UE 102c). Although the method 400 is illustrated in a system level, persons skilled in the art can understand that the method implemented in the three entities can be separately implemented and incorporated in other apparatus with the like functions. It is also contemplated that the method 400 may include additional steps not shown. It is also contemplated that the method 400 may be extended to the multi-hop UE-to-UE relay case.

Steps 401, 402, and 403 may be the same as steps 201, 202, and 203, respectively. That is, in step 401, a first PC5 RRC connection of a first hop between the remote UE1 and the relay UE may be established; in step 402, a second PC5 RRC connection of a second hop between the relay UE and the remote UE2 may be established; and in step 403, after the first PC5 RRC connection and the second PC5 RRC connection are established, a third PC5 RRC connection of an end-to-end PC5 link between the remote UE1 and the remote UE2 may be established. After the third PC5 RRC connection between the remote UE1 and the remote UE2 is established, some configuration may be exchanged between the remote UE1 and the remote UE2. For example, the remote UE1 may transmit an RRC reconfiguration message as described above.

In step 404, the remote UE1 may declare a failure for the third PC5 RRC connection when certain situations (e.g., at least one situation as described above with respect to step 304) occur, but it continues to keep the configuration for the third PC5 RRC connection; this is allowable due to that the configuration for the third PC5 RRC connection is transparent to the relay UE. In some embodiments, in the case that the remote UE1 is in a coverage of a BS, it may transmit information indicating the failure for the third PC5 RRC connection to the BS after declaring the failure for the third PC5 RRC connection, as described above with respect to step 306.

In step 405, the remote UE1 may perform a recovery procedure (i.e., initiate recovery of the third PC5 RRC connection) to reselect a candidate relay UE to re-establish the PC5 RRC connection of an end-to-end PC5 link between the remote UE1 and the remote UE2 by reusing the configuration for the third PC5 RRC connection; this helps to save signaling overhead and improve process efficiency.

To keep the configuration for the third PC5 RRC connection, the remote UE1 may indicate to an upper layer to maintain a keep-alive procedure for the end-to-end PC5 link between the remote UE1 and the remote UE2, such that the end-to-end PC5 link between the remote UE1 and the remote UE2 will not be released even when a timer for the keep-alive procedure expires.

In some embodiments, the remote UE1 may be configured with a recovery timer. Upon declaring the failure for the third PC5 RRC connection or initiating the recovery of the third PC5 RRC connection, the remote UE1 may start the recovery timer. The remote UE1 may stop the recovery timer when a candidate relay UE is selected or a PC5 RRC connection towards the candidate relay UE is established. The remote UE1 may release the third PC5 RRC connection when the recovery timer expires. The configuration for the third PC5 RRC connection is also released upon expiry of the recovery timer.

After a PC5 RRC connection of an end-to-end PC5 link between a first remote UE and a second remote UE is established, SRAP packets may be transmitted from the first remote UE to the second remote UE via at least one relay UE. SRAP headers for each hop may include IDs associated with the first remote UE and the second remote UE. For example, the IDs may be layer-2 IDs or local IDs. A layer- 2 ID may include 24 bits, while a local ID may include fewer bits than the layer-2 ID. It is needed to determine which kind of IDs are to be used in SRAP headers for the hops.

In some embodiments, the first remote UE may decide which kind of IDs are to be used in the SRAP headers for the hops.

If the first remote UE decides to use layer-2 IDs in the SRAP headers for the hops, then no further configuration exchange is needed.

If the first remote UE decides to use local IDs in the SRAP headers for the hops, it may assign local IDs for the first remote UE and the second remote UE respectively, and transmit the assigned local IDs to at least one of the second remote UE and the relay UE. Alternatively, the first remote UE may inform the relay UE to assign the local IDs for the first remote UE and the second remote UE respectively; and then the relay UE may assign the local IDs for the first remote UE and the second remote UE respectively and transmit the local IDs to the first remote UE and the second remote UE.

In some embodiments, the relay UE may decide which kind of IDs are to be used in the SRAP headers for the hops.

If the relay UE decides to use layer-2 IDs in the SRAP headers for the hops, it may transmit, to the first remote UE and the second remote UE, an indication indicating that the layer-2 IDs are to be used in the SRAP headers for the hops.

If the relay UE decides to use local IDs in the SRAP headers for the hops, it may assign the local IDs for the first remote UE and the second remote UE respectively, and transmit the assigned local IDs to the first remote UE and the second remote UE.

In some embodiments, in the case that the first remote UE is inside the coverage of a BS, the BS may determine which kind of IDs are to be used in the SRAP headers for the hops.

If the BS decides to use layer-2 IDs in the SRAP headers for the hops, then no further configuration exchange is needed.

If the BS decides to use local IDs in the SRAP header for the hops, it may assign local IDs for the first remote UE and the second remote UE respectively. The BS may transmit the assigned local IDs to the first remote UE and/or the second remote UE, whichever is in the coverage of the BS. If one of the first remote UE and the second remote UE is in the coverage of the BS while the other is out of the coverage of the BS, the in-coverage UE may forward the received local IDs to the out-of-coverage UE.

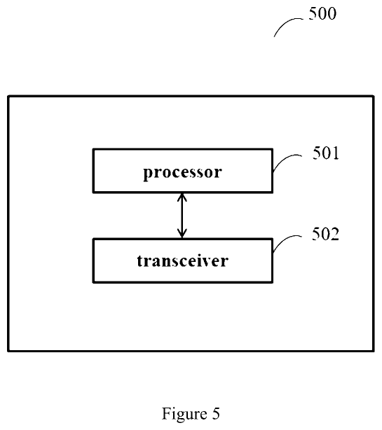

FIG. 5 illustrates a simplified block diagram of an exemplary apparatus 500 according to some embodiments of the present disclosure.

As shown in FIG. 5, an example of the apparatus 500 may include at least one processor 501 and at least one transceiver 502 coupled to the processor 501. The apparatus 500 may be a remote UE, a relay UE, a BS or any other device with similar functions.

Although in this figure, elements such as the transceiver 502 and the processor 501 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a remote UE. The transceiver 502 and the processor 501 may interact with each other so as to perform the operations of a remote UE as described with respect to any of FIGS. 2-4 or other embodiments described in the present disclosure. For example, the processor 501 may be configured to: establish a first PC5 RRC connection of a first hop between the remote UE and a relay UE, and establish a third PC5 RRC connection of an end-to-end PC5 link between the remote UE and a second remote UE via the relay UE, wherein a second PC5 RRC connection of a second hop between the relay UE and the second remote UE is established.

In some embodiments of the present disclosure, the apparatus 500 may be a BS. The transceiver 502 and the processor 501 may interact with each other so as to perform the operations of a BS as described with respect to any of FIGS. 2-4 or other embodiments described in the present disclosure. For example, the processor 501 may be configured to transmit, via the transceiver 502, end-to-end PC5 configuration information for a PC5 RRC connection of an end-to-end PC5 link between a first remote UE and a second remote UE.

In some embodiments of the present disclosure, the apparatus 500 may be a relay UE. The transceiver 502 and the processor 501 may interact with each other so as to perform the operations of a relay UE as described with respect to any of FIGS. 2-4 or other embodiments described in the present disclosure. For example, the processor 501 may be configured to: establish a first PC5 RRC connection of a first hop between a first remote UE and the relay UE; establish a second PC5 RRC connection of a second hop between a second remote UE and the relay UE; and transfer a data unit received from the first remote UE to the second remote UE.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 501 to implement any method described above with respect to a UE (e.g., remote UE or relay UE). For example, the computer-executable instructions, when executed, may cause the processor 501 interacting with the transceiver 502 to perform the operations of a UE as described with respect to any of FIGS. 2-4 or other embodiments described in the present disclosure.

In some embodiments of the present disclosure, the non-transitory computer-readable medium may have stored thereon computer-executable instructions to cause the processor 501 to implement any method described above with respect to a BS. For example, the computer-executable instructions, when executed, may cause the processor 501 interacting with the transceiver 502 to perform the operations of a BS as described with respect to FIGS. 2-4 or other embodiments described in the present disclosure.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first user equipment (UE), comprising:
at least one memory; and
at least one processor coupled with the at least one memory and configured to cause the first UE to:
establish a first PC5 radio resource control (RRC) connection of a first hop between the first UE and a relay UE, wherein a second PC5 RRC connection of a second hop between the relay UE and a second UE is established in response to the first PC5 RRC connection; and
establish a third PC5 RRC connection of an end-to-end PC5 link between the first UE and the second UE via the relay UE.

2. The first UE of claim 1, wherein the first UE is configured with a first value for a timer for reconfiguration of the first PC5 RRC connection, and a second value for a timer for reconfiguration of the third PC5 RRC connection.

3. The first UE of claim 2, wherein the at least one processor is configured to cause the first UE to declare a failure for the third PC5 RRC connection in response to at least one of:
the timer for reconfiguration of the third PC5 RRC connection expires, wherein the timer for reconfiguration of the third PC5 RRC connection is started when the first UE transmits an RRC reconfiguration message including end-to-end PC5 configuration information to the second UE;
an RRC reconfiguration failure message is received from the second UE;
a sidelink (SL) radio link failure (RLF) on the first hop is detected;
a signal strength on the first hop is lower than a first threshold; or
a notification message or a release message is received from the relay UE that indicates that an SL RLF on the second hop is detected or a signal strength on the second hop is lower than a second threshold.

4. The first UE of claim 3, wherein the at least one processor is configured to cause the first UE to release the third PC5 RRC connection upon declaring the failure for the third PC5 RRC connection.

5. The first UE of claim 3, wherein the at least one processor is configured to cause the first UE to transmit, information indicating the failure for the third PC5 RRC connection to a base station (BS).

6. The first UE of claim 5, wherein the information indicating the failure for the third PC5 RRC connection comprises a cause for the failure.

7. The first UE of claim 6, wherein a value of the cause for the failure comprises:
an end-to-end RLF;
an end-to-end configuration failure;
an SL RLF on the first hop;
a low signal strength on the first hop;
an SL RLF on the second hop; or
a low signal strength on the second hop.

8. The first UE of claim 3, wherein the at least one processor is configured to cause the first UE to:
keep a configuration for the third PC5 RRC connection and initiate recovery of the third PC5 RRC connection when the failure for the third PC5 RRC connection is declared.

9. The first UE of claim 8, wherein the at least one processor is configured to cause the first UE to:
release the third PC5 RRC connection when a recovery timer expires, wherein the recovery timer is started upon initiating the recovery of the third PC5 RRC connection or declaring the failure for the third PC5 RRC connection.

10. The first UE of claim 8, wherein to, keep the configuration for the third PC5 RRC connection, the at least one processor is configured to cause the first UE to:
indicate to an upper layer to maintain a keep-alive procedure for the end-to-end PC5 link.

11. The first UE of claim 1, wherein the at least one processor is configured to cause the first UE to determine whether layer-2 identifiers (IDs) or local IDs are used in sidelink relay adaption protocol (SRAP) headers for the first hop and the second hop after the third PC5 RRC connection is established.

12. The first UE of claim 11, wherein, in response to determining to use the local IDs in the SRAP headers for the first hop and the second hop, the at least one processor is configured to cause the first UE to:
assign the local IDs for the first UE and the second UE respectively; or
instruct the relay UE to assign the local IDs for the first UE and the second UE respectively.

13. The first UE of claim 1, wherein the at least one processor is configured to cause the first UE to receive, from the relay UE:
an indication indicating that layer-2 IDs are used in SRAP headers for the first hop and the second hop; or
local IDs for the first UE and the second UE.

14. The first UE of claim 1, wherein the at least one processor is further configured to cause the first UE to:
receive local IDs for the first UE and the second UE.

15. A base station (BS), comprising:
at least one memory; and
at least one processor coupled with the at least one memory and configured to cause the BS to:
transmit, end-to-end PC5 configuration information for a PC5 radio resource control (RRC) connection of an end-to-end PC5 link between a first user equipment (UE) and a second UE; and
receive information indicating a status of the PC5 RRC connection from the first UE.

16. The BS of claim 15, wherein the at least one processor is configured to cause the BS to receive information indicating a failure for the PC5 RRC connection from the first UE, and wherein the information indicates at least one of:
a timer for reconfiguration of the PC5 RRC connection expires;
the first UE receives an RRC reconfiguration failure message from the second UE;
a sidelink (SL) radio link failure (RLF) on a first hop between the first UE and a relay UE is detected;
a signal strength on the first hop is lower than a first threshold;
an SL RLF on a second hop between the relay UE and the second UE is detected; or
a signal strength on the second hop is lower than a second threshold.

17. The BS of claim 15, wherein, in response to the PC5 RRC connection being established, the at least one processor is configured to cause the BS to determine whether layer-2 identifiers (IDs) or local IDs are used in sidelink relay adaption protocol (SRAP) headers for a first hop between the first UE and a relay UE and a second hop between the relay UE and the second UE.

18. The BS of claim 17, wherein, in response to determining to use the local IDs in the SRAP headers for the first hop and the second hop, the at least one processor is configured to cause the BS to:
assign the local IDs for the first UE and the second UE; and
transmit, the local IDs to the first UE or the second UE.

19. A relay user equipment (UE), comprising:
at least one memory; and
at least one processor coupled with the at least one memory and configured to cause the relay UE to:
establish a first PC5 radio resource control (RRC) connection of a first hop between a first UE and the relay UE;
establish a second PC5 RRC connection of a second hop between a second UE and the relay UE; and
transfer a data unit received from the first UE to the second UE.

20. The relay UE of claim 19, wherein the at least one processor is configured to cause the relay UE to:
assign local identifiers (IDs) to be used in sidelink relay adaptation protocol (SRAP) headers for the first hop and the second hop in response to receiving an indication from the first UE to assign the local IDs.
